(19) United States
(12) Patent Application Publication
(10) Pub. No.: US 2025/0078539 A1
(43) Pub. Date: Mar. 6, 2025

(54) METHOD OF PHONE NUMBER RECOGNITION AND SYSTEM FOR USING THE SAME

(71) Applicant: Rakuten Symphony, Inc., Tokyo (JP)

(72) Inventors: Rakesh KOTA, Tokyo (JP); Kalpesh RAWAL, Tokyo (JP); Anindya NANDI, Tokyo (JP)

(21) Appl. No.: 18/038,027

(22) PCT Filed: Jan. 19, 2023
(86) PCT No.: PCT/US2023/011112

§ 371 Date: May 22, 2023

(51) Int. Cl. G06V 20/62

(52) U.S. Cl. CPC G06V 20/63

(57) ABSTRACT

A mobile device includes a display, a non-transitory computer readable medium configured to store instructions thereon, and a processor connected to the non-transitory computer readable medium and the display. The processor is configured to execute the instructions for receiving image data. The processor is further configured to execute the instructions for determining a phone number based on the imaging data. The processor is further configured to execute the instructions for, in response to the phone number being determined, automatically causing the display to: display the phone number, wherein the display is configured to receive instructions for contacting the displayed phone number.

### TECHNICAL FIELD

This description relates to a method of phone number recognition and a system for using the same.

### BACKGROUND

People often come across situations where numbers are printed on paper or digitally displayed on an electronic device. For example, people usually find phone numbers provided on a printed poster/flyer from an advertisement. People sometimes take pictures of the printed advertisement and share the advertisement with other people who may be interested in the information on the advertisement. Generally, people look at the numbers and manually type the numbers on a mobile device to make a phone call.

### SUMMARY

In some embodiments, a mobile device includes a display; a non-transitory computer readable medium configured to store instructions thereon; and a processor connected to the non-transitory computer readable medium and the display. The processor is configured to execute the instructions for receiving image data. The processor is further configured to execute the instructions for determining a phone number based on the imaging data. The processor is further configured to execute the instructions for, in response to the phone number being determined, automatically causing the display to: display the phone number, wherein the display is configured to receive instructions for contacting the displayed phone number.

In some embodiments, a method of a mobile device includes receiving image data. The method further includes determining a phone number based on the image data. The method further includes in response to the phone number being determined, automatically displaying, on a display of the mobile device, the phone number, wherein the display receives instructions for contacting the displayed phone number.

In some embodiments, a non-transitory computer readable medium configured to store instructions for causing a processor executing the instructions to implement a method. The instructions cause the processor to receive image data. The instructions further cause the processor to determine a phone number based on the image data. The instructions further cause the processor to automatically display, on a display of the mobile device, the phone number, wherein the display receives instructions for contacting the displayed phone number.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic block diagram of a system for phone number recognition in accordance with some embodiments.

FIG. 2 is a flowchart of a method of phone number recognition in accordance with some embodiments.

FIG. 3A is a diagram of an example of a dialing screen in accordance with some embodiments.

FIG. 3B is a diagram of an example of a camera view screen in accordance with some embodiments.

FIG. 3C is a diagram of an example of a dialing screen accordance with some embodiments.

FIG. 4 is a flowchart of a method of phone number recognition in accordance with some embodiments.

FIG. 5A is a diagram of an example of a messaging user interface in accordance with some embodiments.

FIG. 5B is a diagram of an example of a messaging user interface in accordance with some embodiments.

FIG. 5C is a diagram of an example of a dialing screen in accordance with some embodiments.

FIG. 6 is a block diagram of a system for phone number recognition in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

People generally manually type numbers on their mobile devices in order to make phone calls to the phone numbers printed on paper, such as advertisements, or digitally displayed on an electronic device, such as a mobile phone. The manual input for people to enter numbers one by one and is therefore time consuming. Further during the manual input while checking the numbers, one or two wrong numbers might be entered by accident. Sometimes people become irritated by manually entering a phone number on a mobile device.

Text detection technology in a mobile device has been under development in recent years. A smart phone is able to detect the text on a digital image. However, the detect text often requires further editing from users to make a phone call. For example, when some text including numbers are detected, the detected numbers, which might be a phone number or includes a phone number, are not provided in a manner to allow a user to make a phone call. A user cannot make a phone call just by pressing on the detected numbers because the detected numbers are often displayed in combination with other detected characters, such as letters or symbols. In such a case, the detected numbers are not in a valid phone number format for making a call or sending a message.

A system is provided with an application to recognize phone numbers which are visible to human eyes to improve the efficiency of making phone calls in accordance with some embodiments of this description.

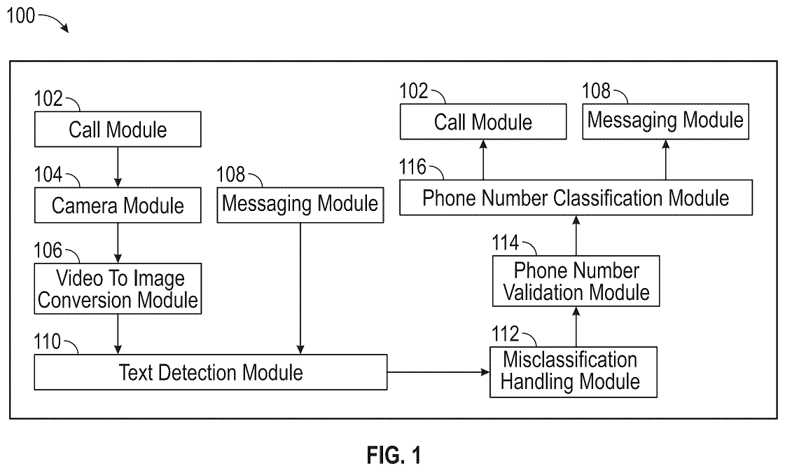

FIG. 1 is a schematic block diagram of a system 100 for phone number recognition in accordance with some embodiments. In some embodiments, the system 100 is implemented in a mobile device, such as a smart phone, a tablet, a watch or other suitable mobile devices. In some embodiments, the system 100 is implemented in a mobile phone. The system 100 includes a call module 102, a camera module 104, a video to image conversion module 106, a messaging module 108, a text detection module 110, a misclassification handling module 112, a phone number validation module 114, and a phone number classification module 116. The mobile device implementing the system 100 has a screen configured to display user interfaces generated by one or more modules in the system 100. The screen is a touchscreen in accordance with some embodiments.

The call module 102 provides a function of making a phone call. The call module 102 is implemented using a processor and/or other hardware. The call module 102 generates a user interface for phone calls, e.g., a dialing screen or a dialing pad. In some embodiments, the user interface of the call module 102 is capable of receiving input from a user of the system 100 or another module in the system 100. For example, the call module 102 receives a phone number that is transmitted from another module of the system 100 or is manually entered through the user interface. In some embodiments, the user interface for phone calls links to a contacts application such that a phone number entered in the user interface is able to be saved in the contacts application. In some embodiments, the user interface for phone calls links to a messaging application such that users are able to send a message to the phone number entered in the user interface.

A link is provided on the user interface generated by the call module 102 for activating a camera function provided by the camera module 104. In some embodiments, the call module 102 provides a button for activating the camera module 104. In some embodiments, an icon indicating a link to a camera function is displayed on the user interface for phone calls to prompt a user to trigger the camera function. The icon is selectable by a user's gesture including, but not limited to, a touch, long touch, release, swipe, tap, double tap, or long tap. In some embodiments, the link for activating the camera module 104 is in a form of a physical button of a mobile device as an example of the system 100.

The camera module 104 provides a camera function of capturing a picture or a video of an object. The camera module 104 is implemented using a detector and a processor and/or other hardware. When the camera module 104 is activated, a camera viewfinder, e.g., a camera view screen, is provided on the mobile device. The camera module 104 scans text including numbers from the camera view screen. For example, a user can scan text with the camera module 104 when the text appears in the camera view screen. In some embodiments, the camera module 104 captures the text automatically, i.e., without user action. In some embodiments, the cameral module 104 captures the text in response to a detected user action. In some embodiments, the user action includes, but not limited to, a hand gesture such as touch, tap, press on a button of the mobile device, or a voice command.

In some embodiments, the captured data or the scanned data is recorded at 30 frames per second (fps). In some embodiments, the capture data or scanned data is recorded at a different fps, e.g., 60 fps. The captured data is transmitted from the camera module 104 to a video to image conversion module 106. The video to image conversion module 106 is implemented using a processor and/or other hardware. The video to image conversion module 106 converts the captured data or the scanned data into an image sequence including a plurality of images. The video to image conversion module 106 identifies one of the plurality of images that has a best quality for further processing. In some embodiments, the video to image conversion module 106 determines whether the quality of the image satisfies a predetermined threshold based on several factors, such as contrast, blur, noise, artifacts, and distortion. In some embodiments, other factors are considered to determine the image with the best quality. The video to image conversion module 106 filters out the images that do not satisfy the predetermined threshold.

In some embodiments, an alert or a notification is generated in response to determining the images lack sufficient quality for further processing. In some embodiments, a notification bar or screen is displayed on the mobile device. In some embodiments, the alert or notification is communicated to the user using sound generated from a speaker of the mobile device. In some embodiments, the alert or notification communicated to the user by vibration of the mobile device. Further in some embodiments, a suggestion to recapture an image or a video of the object is generated on the mobile device when the images do not have sufficient quality. In some embodiments, the suggestion is provided with the notification bar or screen or provided as a separate pop-up window displayed on the mobile device. The identified image by the video to image conversion module 106 is transmitted to the text detection module 110 for processing.

The messaging module 108 generates a messaging user interface including a conversation transcript of a messaging session between a user of the mobile device and at least one other user. The messaging module 108 is implemented using a processor and/or other hardware. The messaging module 108 receives and sends information including text, images, videos, or digital documents to another system via a network, such as a local area network (LAN), a wide area network (WAN), the Internet, or a combination thereof. In some embodiments, the received and sent information are displayed on the messaging user interface provided by the messaging module 108 and selectable to transmit to the text detection module 110 for processing.

In some embodiments, the messaging module 108 is able to activate the camera module 104. For example, the screen of the mobile device displays on the messaging user interface a camera icon for executing a camera function. In response to detecting the camera icon being selected, the messaging module 108 activates the camera module 104 for taking an image or a video.

The text detection module 110 detects text in an image. The text detection module 110 is implemented using a processor and/or other hardware. In some embodiments, the text detection module 110 is configured based on Apple®'s Vision framework. In some embodiments, the text detection application is different from Apple®'s Vision framework. The text detection module 110 performs allows the use of Machine Learning (ML) models for text detection. In some embodiments, the text detection module 110 receives one or more images from the video to image conversion module 106 and the messaging user module 108 and detects text from the one or more images. The detected text includes numerical data and non-numerical data. The text detection module 110 outputs the detected text including the numerical data and the non-numerical data to the misclassification handling module 112.

Upon receiving the detected text from the text detection module 110, the misclassification handling module 112 filters any misclassification in a form of non-numerical data and outputs numerical data for further processing at the phone number validation module 114. For example, when an image with numbers is transmitted to the text detection application 110, the detected text includes numeral data, i.e., numbers, and non-numerical data, i.e., letters, or symbols. In such a case, the numeral data, i.e., the numbers, are transmitted to the phone number validation module 114. Therefore, the accuracy of phone number recognition is improved in comparison with other approaches that do not include the misclassification handling module 112.

The phone number validation module 114 validates a phone number based on the detected numerical data. The phone number validation module 114 is implemented using a processor and/or other hardware. In some situations, some other numbers that are not phone numbers are detected as numerical data, such as pricing, address, etc. The phone number validation module 114 is able to determine whether the detected numbers are valid phone numbers.

In some embodiments, the phone number validation module 114 identifies if any patterns are presented in the detected numerical data. In some embodiments, the patterns include, but not limited to, XXX-XXX-XXXX, XXX XXX XXXX, (XXX)XXX-XXXX, (XXX) XXX-XXXX, XXX.XXX.XXXX, XXX XXX-XXXX, and XXX/XXX.XXXX. In some embodiments, the patterns are in a different format and/or the numbers of digits based on a registration location of the phone number captured. In some embodiments, the patterns are predetermined based on a location of a mobile device implementing the system 100. In some embodiments, the phone number validation module 114 utilizes a Global Positioning System (GPS) implemented by a GPS module of the mobile device to determine a location of the mobile device. The phone number validation module 114 is able to sue the location of the mobile device to determine common phone number patterns in a location of the mobile device, e.g., using a look up table. In some embodiments, the phone number validation module 114 analyzes the detected text to determine what language (Chinese, Japanese, French, English, etc.) is included in the detected text and determines a common format of the phone number based on the language, e.g. using a look up table. For example, when the phone number validation module 114 determines the detected text including Japanese language, a common format of phone numbers in Japan is considered as the phone number pattern for phone number validation. Based on the predetermined patterns, the phone number validation module 114 obtains one or more validated numbers. Validation phone number based on the predetermined patterns improves the accuracy of phone number recognition in comparison with approaches that do not include the phone number validation module 114.

All validated numbers are transmitted from the phone number validation module 114 to the phone number classification module 116. The phone number classification module 116 is implemented using a processor and/or other hardware. The phone number classification module 116 determines a phone number with a highest probability among the validated numbers. In some embodiments, the phone number classification module 116 implements a pre-set algorithm multiple times to output multiple results each of which includes a phone number with a highest probability, and then the phone number classification module 116 determines the phone number with the most frequency in the results as a final phone number with the highest probability. In some embodiments, in a case that numeral data is obtained from the camera module 104, the phone number classification module 116 determines the phone number appeared 10 times in the result as the final phone number with the highest probability. In some embodiments, in a case that numeral data is obtained from the messaging module 108, if a same phone number appears 3 or 4 times in the results, then the phone number is determined as a final phone number with the highest probability. As a result, chances of false determination are substantially reduced.

Upon determination of a final phone number with a highest probability, the call module 102 or the messaging module 108 automatically displays the final phone number. In a case that the call module 102 triggers the camera module 104 to capture or scan numbers, upon determination of a final phone number with a highest probability, the call module 102 automatically displays a dialing screen with the final phone number determined by the phone number classification module 116. Hence, a user can simply press a call button on the dialing screen to make a call to the displayed phone number. In a case that numbers are obtained from the messaging module 108, upon determination of a final phone number with a highest probability, the messaging module 108 automatically displays the final phone number for making a call or sending a message to the displayed phone number. In some embodiments, the call module 102 or the messaging module 108 displays multiple phone numbers on the corresponding user interface when the multiple numbers are determined as final phone numbers with highest probability. The user interface allows a user to select one of the displayed phone numbers for calling or texting. In some embodiments, the functionality of displaying multiple phone numbers with highest probability is optional, for example, a user is able to set the functionality ON or OFF.

The system is able to detect numbers printed on paper or displayed by a display external to the mobile device by using a camera function and automatically carry out phone number recognition. During a phone number recognition process, the system is able to extract numerical data and filter out any misclassification in the form of non-numerical data, and validate the extracted numerical data. The system is further able to automatically display the phone number in response to a phone number being recognized. The displayed phone number is selectable, e.g., by a gesture such as touch, long touch, release, swipe, tap, double tap, or long tap, to make a call or send a message to the displayed phone number. In other words, the system recognizes a phone number from printed or displayed numbers using a camera function and automatically opens a dialing application with that phone number already entered. Hence, a user is able to immediately press a call button to call the phone number. As a result, customer satisfaction is increased because the accuracy of a phone number input to a mobile device is increased and the efficiency of contacting the number is improved.

The system is able to recognize phone numbers digitally displayed on a messaging user interface of a mobile device or displayed by a display external to the mobile device. The messaging user interface includes a conversation transcript of a messaging session between a user of a mobile device and at least one other user of another mobile device. For example, when a user receives an image from another user, the image is displayed on the messaging user interface. The system is able to detect numbers included in the image and automatically carry out phone number recognition. During a phone number recognition process, the system is able to extract numerical data and filter out any misclassification in the form of non-numerical data, and validate the extracted numerical data. The system is further able to automatically display the phone number in response to a phone number being recognized. The displayed phone number is selectable, e.g., by a press or touch gesture of a user, to make a call or send a message to the displayed phone number. In other words, the system directly scans a phone number from an image displayed on a massaging user interface and automatically displays the phone number. Hence, a user is able to immediately press the phone number to make a call or send a message. As a result, accuracy of a phone number input to a mobile device is increased and the efficiency of contacting the number is improved.

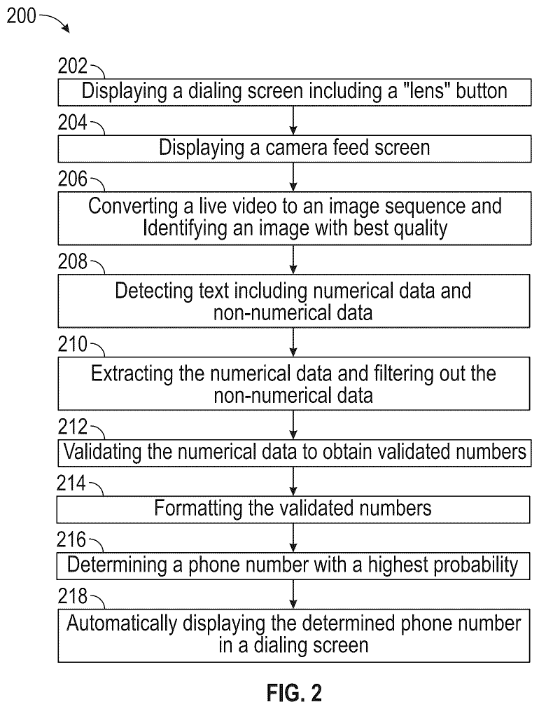

FIG. 2 is a flowchart of a method 200 of phone number recognition in accordance with some embodiments. In some embodiments, the method 200 is implemented by the system 100 (FIG. 1). In some embodiments, the method 200 is implemented by a system other than the system 100 (FIG. 1). In some embodiments, the method 200 is implemented by a mobile device as an example of the system 100 (FIG. 1) to recognize a phone number through a camera of the mobile device so that the mobile device 100 (FIG. 1) is able to make a call or a send a message to the phone number without manual input of the phone number. The method 200 is able to automatically open a dialing screen with the recognized phone number already entered to allow a user to immediately press on a calling button to make a call or to send a message to the recognized phone number.

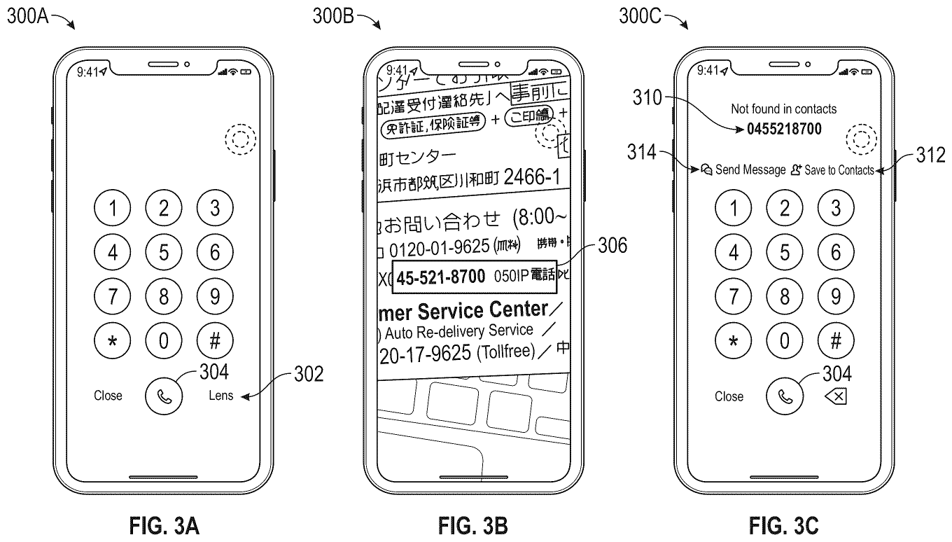

The method 200 includes operation 202 in which a dialing screen is displayed. In some embodiments, displaying a user interface, such as a dialing screen or a dialing pad, for making a phone call is triggered by a call application such as the call module 102 (FIG. 1). FIG. 3A is a diagram of an example of a dialing screen in accordance with some embodiments. The dialing screen 300A in FIG. 3A includes numbers 0-9, * button, # button, a “Close” button. The dialing screen 300A further includes a “Lens” button 302 and a call button 304. In some embodiments according to FIG. 3A, the “Lens” button 302 is arranged at a right side of the call button 310. In some embodiments, the “Lens” button 302 is arranged at a different position. The “Lens” button 302 is selectable to trigger a camera application such as the camera module 104 (FIG. 1). The call button 304 is selectable to make a phone call. Selection of the “Lens” button 302 and the call button 304 is detected by a user gesture including, but not limited to, a touch, tap, or press. In some embodiments, the selection of the “Lens” button 302 is detected by a gesture different from a gesture of selection of the call button 304.

In response to a selection of the “Lens” button, the method 200 proceeds to operation 204. In operation 204, a camera view screen is displayed for capturing a video or picture. In some embodiments, the camera module 104 (FIG. 1) is implemented to capture a video or picture. FIG. 3B is a diagram of an example of a camera view screen in accordance with some embodiments. As shown in FIG. 3B, a camera view screen 300B is displayed. When the camera module 104 (FIG. 1) is activated to capture an object, the camera view screen 300B shows a box 306. In a case that text included in the object, the box 306 focuses on a selected text for detection. That is, when the text appears in the box 306, the text is automatically detected and allows a user operation to capture an image or video of the detected text.

In response to automatically detecting the text in operation 204, the method 200 proceeds to operation 206. In operation 206, a video including the detected text is automatically converted into an image sequence including a plurality of images. In some embodiments, operation 206 automatically converts a live video to an image sequence. In some embodiments, the conversion from a video to an image sequence is performed by the video to image conversion module 106 (FIG. 1). Further in operation 206, one of the converted images that has a best quality is identified for further processing. In some embodiments, the identification of an image with a best quality is performed by the video to image conversion module 106 (FIG. 1). In some embodiments, the identification is processed only at the area with text appeared in the box 306 (FIG. 3B) to improve the image processing efficiency.

In some embodiments, in response to identifying an image having a best quality, the method 200 proceeds to operation 208 in which text including numerical data and non-numerical data is detected. In some embodiments, the method 200 proceeds to operation 208 as soon as operation 206 identifies a first image with sufficient quality. Operation 208 is implemented by a text detection application. In some embodiments, operation 208 is implemented by the text detection module 110 (FIG. 1). In operation 208, the image identified in operation 206 is transmitted to a text detection application and the text detection application outputs a text detection result including detected text. The text detection result is further processed in operation 210. In some embodiments, as shown in FIG. 3B, the detected text in the box 306 includes numerical data, e.g., 4552187000050, and non-numerical data, e.g., IP [symbol] . The detected text appeared in the box 306 is transmitted to operation 210.

Operation 210 extracts the numerical data and filters out the non-numerical data. In some embodiment, the filtering and extracting are implemented by the misclassification handling module 112 (FIG. 1). In some embodiments, a module different from the misclassification handling module 112 (FIG. 1) is used in operation 210. In some embodiments, operation 210 filters out the non-numerical data, e.g., IP [symbol] (FIG. 3B), and extracts the numerical data, e.g., 4552187000050 (FIG. 3B), and transmitted the extracted the numerical data to a next operation.

In response to the numerical data being extracted, the method 200 proceeds to operation 212. Operation 212 validates the numerical data transmitted from operation 210 to obtain validated numbers. In some embodiments, operation 212 is implemented by the phone number validation module 114 (FIG. 1). The numerical data transmitted from operation 210 includes numbers which could be a phone number or numbers that are not phone numbers. For instance, numbers in an address, such as zip codes, street numbers, building numbers or unit numbers, are included in the numerical data. In some embodiments, a regular expression (regex) is applied in operation 212 for number validation. In some embodiments, patterns used in the regex technique are determined based on a location of a mobile device implementing the method 200 or a registration location of the phone number captured in operation 204. For example, when the mobile device is located in the United States, the patterns include, but not limited to, XXX-XXX-XXXX, XXX XXX XXXX, (XXX)XXX-XXXX, (XXX) XXX-XXXX, XXX.XXX.XXXX, XXX XXX-XXXX, and XXX/XXX.XXXX. The numbers of digits are not limited and also determined based on the location of the mobile device implementing the method 200. In some embodiments, operation 212 utilizes a Global Positioning System (GPS) implemented by a GPS module of the mobile device to determine common phone number patterns in an area from a look up table. In some embodiments, operation 212 analyzes the detected text to determine what language (Chinese, Japanese, French, English, etc.) is included in the detected text and determines a common format of the phone number based on the language. For example, when operation 212 determines the detected text including Japanese language, a common format of phone numbers in Japan is considered as the phone number pattern for phone number validation. Operation 212 validates phone numbers by determining whether the numerical data includes numbers satisfying any of the patterns. In some embodiments, the patterns are stored in a memory of the mobile device implementing the method 200. In some embodiments, the predetermined patterns are obtained from an external server via a network.

In response to validated numbers being obtained in operation 212, the method 200 proceeds to operation 214. Operation 214 formats the validated numbers transmitted from operation 212. In some embodiments, formatting the validated numbers is implemented by the phone number validation module 114 (FIG. 1). In some embodiments, a different model from the phone number validation module 114 (FIG. 1) is used in operation 214. In some embodiments, the validated numbers are not arranged in a format for making a call. For example, a call module does not recognize a phone number if the numbers do not include an area/region code. Operation 214 formats the validated numbers by adding or arranging an area/region code based on a location of a mobile device implementing the method 200.

In response to the validated numbers being formatted in operation 214, the method 200 proceeds to operation 216. Operation 216 determines a phone number with a highest probability. In some embodiments, operation 216 is implemented by the phone number classification module 116 (FIG. 1). In some embodiments, a different model from the phone number classification module 116 (FIG. 1) is in operation 216.

Operation 216 applies an algorithm to determine a phone number with the highest probability among validated numbers. In some embodiments, operation 216 processes the algorithm multiple times to output multiple results each of which includes a phone number with a highest probability, and then determines a phone number with the most frequency in the results as a final phone number with a highest probability. In some embodiments, operation 216 determines the phone number appeared 10 times in the result as the final phone number with the highest probability. If the phone number appeared less than 10 times in the determination of operation 216, a likelihood of providing a false result of the determination of the phone number with the highest probability will be increased.

In response to the phone number with the highest probability being determined in operation 216, the method 200 proceeds to operation 218 in which the phone number with the highest probability is automatically displayed in a dialing screen on a display of a mobile device implementing the method 200. As a result, a phone call to the displayed phone number can be immediately made. In some embodiments, operation 216 is implemented by the call module 102 (FIG. 1). In some embodiments, operation 216 is implemented by a different module.

In some embodiments, an instruction on the dialing screen is received to make a call or send a message to the displayed phone number. FIG. 3C is a diagram of an example of a dialing screen in accordance with some embodiments. As shown in FIG. 3C, phone number 310 corresponding to the numbers appeared in the box 306 (FIG. 3B) is displayed on the dialing screen 300C. A call can be made to the phone number 310 by selecting the call button 304.

In some embodiments, an instruction on the dialing screen is received to save the displayed phone number to contacts. According to some embodiments in FIG. 3C, saving the displayed phone number can be made by selecting a save button 312. In some embodiments, an instruction on the dialing screen is received to send a message to the displayed phone number. According to some embodiments in FIG. 3C, sending a message can be made by selecting a messaging button 314.

One of ordinary skill in the art would understand that modifications to the method 200 are within the scope of this description. In some embodiments, at least one additional operation is included in the method 200. For example, in some embodiments, the user is prompted to determine whether to contact the displayed phone number using a phone call or a messaging function on the mobile device. In some embodiments, at least one operation of the method 200 is omitted. For example, in some embodiments, the operation 216 is omitted when only a single phone number is identified in operation 212. In some embodiments, an order of operations of the method 200 is adjusted. For example, in some embodiments, the operation 216 is performed prior to the operation 214.

FIGS. 3A, 3B, and 3C are diagrams of a user interface of a mobile device in accordance with some embodiments.

FIG. 3A is a diagram of an example of a dialing screen 300A displayed on a display of a mobile device. The dialing screen 300A includes a call button 304 and a “Lens” button 302. In some embodiments, the “Lens” button is selected to activate a camera application. In some embodiments, the “Lens” button is selected to activate the camera module 104 (FIG. 1). In response to the “Lens” button is selected, a camera view screen is displayed.

FIG. 3B is a diagram of an example of a camera view screen 300B displayed on a display of a mobile device. The camera view screen 300B includes a box 306 for scanning or capturing an object, such as text. As shown in FIG. 3B, the text, i.e., 45-521-8700 050IP [symbol] [symbol] , appears in the box 306. In response to the box 306 capturing the text of the object, a dialing screen including a phone number recognized based on the captured text in the box 306 is automatically displayed. In other words, the phone number recognized based on the captured text in the box 306 is automatically displayed.

FIG. 3C is a diagram of an example of a dialing screen 300C displayed on a display of a mobile device. The dialing screen 300C includes phone number 310 recognized based on the captured text in the box 306 (FIG. 3C). The dialing screen 300C further includes the call button 304. In some embodiments as shown in FIG. 3C, the dialing screen 300C does not include the “Lens” button 302. In some embodiments, the “Lens” button 302 is included in a dialing screen that includes the displayed phone number. In response an instruction of making a call, such as a gesture of pressing on the call button 304 of the dialing screen 300C, being received, a call to the displayed phone number is made. In some embodiments, an instruction can be made by voice or pressing on a physical button of the mobile device to make a call or send a message to the displayed phone number.

The dialing screen 300C in FIG. 3C further includes a save button 312 for saving the displayed phone number to contacts, and a messaging button 314 for sending a message to the displayed phone number.

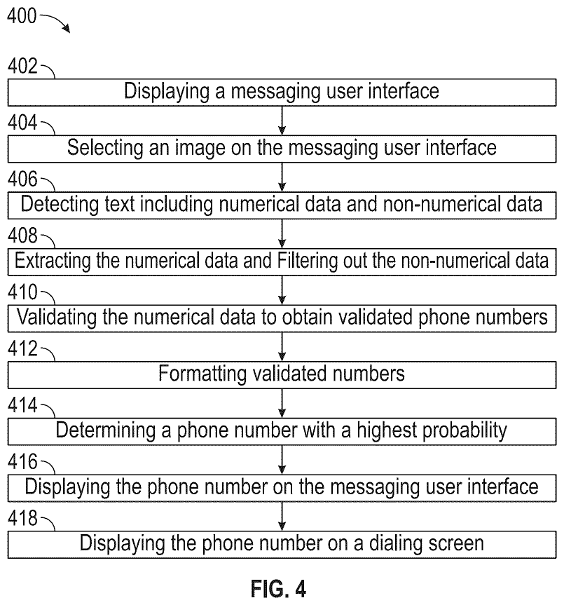

FIG. 4 is a flowchart of a method of phone number recognition in accordance with some embodiments. In some embodiments, the method 400 is implemented by system 100 (FIG. 1). In some embodiments, the method 400 is implemented by a system other than the system 100 (FIG. 1). In some embodiments, the method 400 is implementable by a mobile device as an example of system 100 (FIG. 1) to recognize a phone number in an image displayed on a messaging user interface and automatically display the recognized phone number so that a user can immediately make a call or send a message to the displayed phone number. Thus, the method 400 makes a call to the displayed phone number without a user's manual input of the phone number.

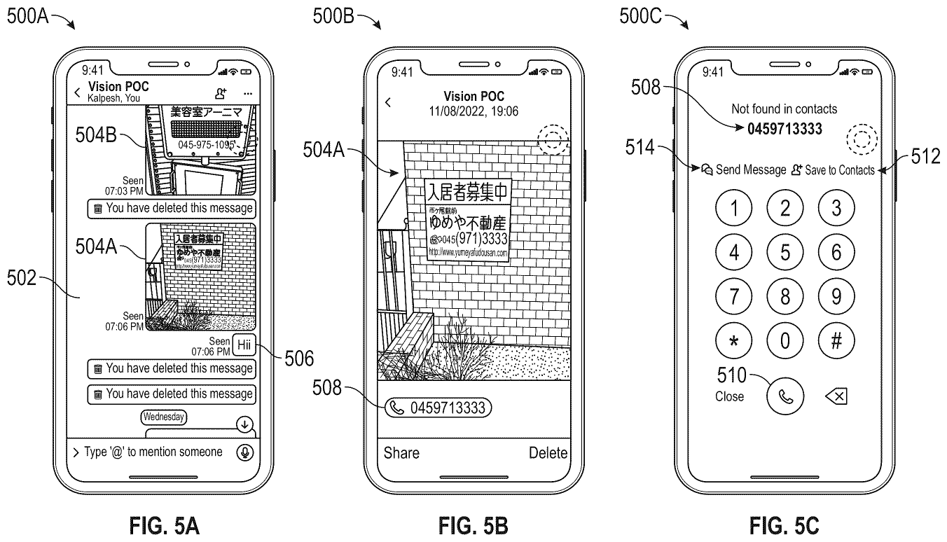

Method 400 includes operation 402 in which a messaging user interface is displayed. In some embodiments, operation 402 is implemented by a messaging application. In some embodiments, operation 402 is implemented by the messaging module 108 (FIG. 1). The messaging user interface allows a user to send and receive messages, images, videos and documents. In some embodiments, the images included in a conversation transcript are selectable individually or in combination for further processing. In some embodiments, an image on the messaging user interface is selectable by a gesture including, but not limited to, a touch, a click, or a press. In some embodiments, an image on the messaging user interface is selectable by voice. FIG. 5A is a diagram of an example of a messaging user interface in accordance with some embodiments. In some embodiments as shown in FIG. 5A, a messaging user interface 500A is displayed on a display of a mobile device. The messaging user interface 500A shows a conversation transcript that includes images 504A, 504B and messages, e.g., message 506. The images 504A and 504B are selectable individually or in combination.

Method 400 includes operation 404 in which a selection of an image displayed on the messaging user interface is detected. When an image on the messaging user interface is selected, operation 404 detects the selection of the image and displays the selected image. In some embodiments, the selected image is displayed on the messaging user interface in an enlarged manner. FIG. 5B is a diagram of an example of a messaging user interface in accordance with some embodiments. As shown in FIG. 5B, the selected image 504A is enlarged and displayed on the messaging user interface 500B.

In response to detecting that the image on the messaging user interface is selected in operation 404, the method 400 proceeds to operation 406 in which text including numerical data and non-numerical data is detected from the selected image. Operation 406 is implemented by a text detection application. In some embodiments, operation 406 is implemented by the text detection module 110 (FIG. 1). In operation 406, the text detection application processes the image selected in operation 404 and outputs a text detection result including detected text. In some embodiments, as shown in FIG. 5B, the detected text includes numerical data, e.g., 0459713333, and non-numerical data, e.g., Japanese characters, symbols, and other environmental data. The detected text is further processed in operation 408 of the method 400.

Operation 408 extracts the numerical data and filters out the non-numerical data. In some embodiment, the filtering and extracting in operation 408 are implemented by the misclassification handling module 112 (FIG. 1). In some embodiments, a module different from the misclassification handling module 112 (FIG. 1) is used in operation 408. In some embodiments, operation 210 filters out the non-numerical data, e.g., Japanese characters, symbols, and other environmental data (FIG. 5B), and extracts the numerical data, e.g., 0459713333 (FIG. 5B), and transmitted the extracted the numerical data to a next operation.

In response to the numerical data being extracted, the method 400 proceeds to operation 410. Operation 410 validates the numerical data transmitted from operation 408 to obtain validated numbers. In some embodiments, operation 410 is implemented by the phone number validation module 114 (FIG. 1). The numerical data transmitted from operation 410 includes numbers which could be a phone number or numbers that are not phone numbers. For instance, numbers in an address, such as zip codes, street numbers, building numbers or unit numbers, are included in the numerical data. In some embodiments, a regular expression (regex) is applied in operation 410 for number validation. In some embodiments, patterns used in the regex technique are determined based on a location of a mobile device implementing the method 400. For example, when a user is located in the United States, the patterns include, but not limited to, XXX-XXX-XXXX, XXX XXX XXXX, (XXX)XXX-XXXX, (XXX) XXX-XXXX, XXX.XXX.XXXX, XXX XXX-XXXX, and XXX/XXX.XXXX. The numbers of digits are not limited and also determined based on the location of the mobile device implementing the method 400 or a registration location of the phone number captured in operation 404. In some embodiments, operation 410 utilizes a Global Positioning System (GPS) implemented by a GPS module of the mobile device to determine common phone number patterns in an area from a look up table. In some embodiments, operation 410 analyzes the detected text to determine what language (Chinese, Japanese, French, English, etc.) is included in the detected text and determines a common format of the phone number based on the language. For example, when operation 410 determines the detected text including Japanese language, a common format of phone numbers in Japan is considered as the phone number pattern for phone number validation. Operation 410 validates phone numbers by determining whether the numerical data includes numbers satisfying any of the patterns. In some embodiments, the patterns are stored in a memory of the mobile device implementing the method 400. In some embodiments, the predetermined patterns are obtained from an external server via a network.

In response to validated numbers being obtained in operation 410, the method 400 proceeds to operation 412. Operation 412 formats the validated numbers transmitted from operation 410. In some embodiments, formatting the validated numbers is implemented by the phone number validation module 114 (FIG. 1). In some embodiments, a different model from the phone number validation module 114 (FIG. 1) is used in operation 412. In some embodiments, the validated numbers are not arranged in a format for making a call. For example, a call module does not recognize a phone number if the numbers do not include an area/region code. Operation 412 formats the validated numbers by adding or arranging an area/region code based on a location of a mobile device implementing the method 400.

In response to the validated numbers being formatted in operation 412, the method 400 proceeds to operation 414. Operation 414 determines a phone number with a highest probability. In some embodiments, operation 414 is implemented by the phone number classification module 116 (FIG. 1). In some embodiments, a different model from the phone number classification module 116 (FIG. 1) is in operation 414.

Operation 414 applies an algorithm to determine a phone number with the highest probability among validated numbers. In some embodiments, operation 414 processes the algorithm multiple times to output multiple results each of which includes a phone number with a highest probability, and then determines a phone number with the most frequency in the results as a final phone number with a highest probability. In some embodiments, operation 414 determines the phone number appeared 3 or 4 times in the result as the final phone number with the highest probability. If the phone number appeared less than 3 or 4 times in the determination of operation 414, a likelihood of providing a false result of the determination of the phone number with the highest probability will be increased.

In response to determining a phone number with a highest probability in operation 414, the method 400 proceeds to operation 416 in which the determined phone number is displayed on the messaging user interface. In some embodiments, the phone number is displayed adjacent to the image on the messaging user interface. In some embodiments as shown in FIG. 5B, the phone number 508, i.e., 0459713333, is displayed below the selected image 504A on the messaging user interface 500B. The phone number is displayed in a manner to prompt a user to make a phone call or send a message. In some embodiments, a calling icon is displayed in front of the phone number. In some embodiments, the phone number is displayed in a predetermined color to indicate that the phone number is selectable for contacting the phone number. In some embodiments, the displayed phone number is bolded or underlined.

In response to selecting the displayed phone number on the messaging user interface, the method 400 proceeds to operation 418 which displays the selected phone number on a dialing screen. Operation 418 stops displaying the messaging user interface to start displaying the dialing screen including the selected phone number. As a result, a phone call to the displayed phone number can be immediately made. In some embodiments, operation 418 is implemented by the call module 102 (FIG. 1). In some embodiments, operation 418 is implemented by a different module.

In some embodiments, an instruction on the dialing screen is received to make a call or send a message to the displayed phone number. FIG. 5C is a diagram of an example of a dialing screen in accordance with some embodiments. As shown in FIG. 5C, the phone number 508, i.e., 0459713333, is displayed on the dialing screen 500C. A call can be immediately made to the phone number 508 by selecting a call button 510.

In some embodiments, an instruction on the dialing screen is received to save the displayed phone number to contacts. According to some embodiments in FIG. 5C, saving the displayed phone number can be made by selecting a save button 512. In some embodiments, an instruction on the dialing screen is received to send a message to the displayed phone number. According to some embodiments in FIG. 5C, sending a message can be made by selecting a messaging button 514.

One of ordinary skill in the art would understand that modifications to the method 400 are within the scope of this description. In some embodiments, at least one additional operation is included in method 400. For example, in some embodiments, a selection of more than one image that numerical data is included in method 400. In some embodiments, recognition of more than one phone number is included in method 400. For example, when two phone numbers are determined with the highest probability, both of the two phone numbers are displayed on the messaging user interface. In some embodiment, at least one operation is omitted from method 400. For example, in some embodiments, if the validated numbers are already in a phone number format, operation 412 for formatting the validated numbers is omitted from method 400. In some embodiments, an order of operations of method 400 is adjusted. For example, in some embodiments, the operation 414 is performed prior to the operation 412.

FIGS. 5A, 5B, and 5C are diagrams of a user interface of a mobile device in accordance with some embodiments.

FIG. 5A is a diagram of an example of a messaging user interface 500A displayed on a display of a mobile device. The messaging user interface 500A displays a conversation transcript including images 504A and 504B and message 506. The images 504A and 504B are selectable for phone number recognition.

FIG. 5B is a diagram of an example of a messaging user interface 500B in accordance with some embodiments. In response to that a selection of image 504A displayed on the messaging user interface 500A is detected, the selected image 504A is displayed on the messaging user interface 500B and a phone number 508 recognized from the selected image 504A is displayed adjacent to the image 504A. In some embodiments, the selected image 504A is enlarged. In some embodiments, the recognized phone number 508 is displayed immediately below the image 504A. The recognized phone number is displayed in a manner to indicate that the phone number is selectable for making a phone call. In some embodiments, a calling icon is displayed in front of the recognized phone number. In some embodiments, the phone number is displayed in a predetermined color.

FIG. 5C is a diagram of an example of a dialing screen 500C in accordance with some embodiments. In response to a selection of the recognized phone number 508 in FIG. 5B, the recognized phone number 508 is displayed on the dialing screen 500C. A call can be immediately made to the phone number 508 by selecting a call button 510. The dialing screen 500C in FIG. 5C further includes a save button 512 for saving the displayed phone number to contacts, and a messaging button 514 for sending a message to the displayed phone number.

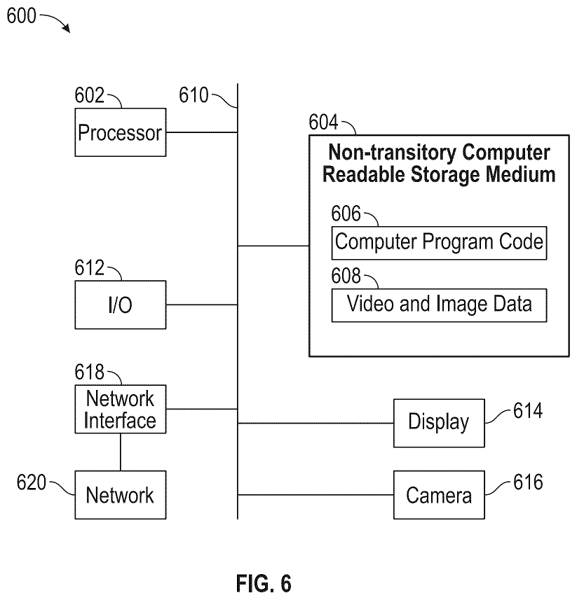

FIG. 6 is a block diagram of system 600 for phone number recognition in accordance with some embodiments. A mobile device is an example of system 600. System 600 includes a hardware processor 602 and a non-transitory computer readable storage medium 604 encoded with, i.e., storing, the computer program code 606, i.e., a set of executable instructions. Computer readable storage medium 604 also stores video and image data 608 obtained by a camera or received from a messaging application. The processor 602 is electrically coupled to the computer readable storage medium 604 via a bus 610. The processor 602 is also electrically coupled to an I/O interface 612 by bus 610. A display 614 is electrically connected to the processor 602 via bus 610. A camera 616 is also electrically connected to the processor 602 via bus 610. A network interface 614 is also electrically connected to the processor 602 via bus 610. A network interface 618 is connected to a network 620, so that processor 602 and computer readable storage medium 604 are capable of connecting to external elements via network 620. The processor 602 is configured to execute the computer program code 606 encoded in the computer readable storage medium 604 in order to cause system 600 to be usable for performing a portion or all of the operations as described in method 200 (FIG. 2) or method 400 (FIG. 4).

In some embodiments, the processor 602 is a central processing unit (CPU), a multi-processor, a distributed processing system, an application specific integrated circuit (ASIC), and/or a suitable processing unit.

In some embodiments, the computer readable storage medium 604 is an electronic, magnetic, optical, electromagnetic, infrared, and/or a semiconductor system (or apparatus or device). For example, the computer readable storage medium 604 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 604 includes a compact disk-read only memory (CD-ROM), a compact disk-read/write (CD-R/W), and/or a digital video disc (DVD).

In some embodiments, the storage medium 604 stores the computer program code 606 configured to cause system 600 to perform a portion or all of the operations as described in method 200 (FIG. 2) or method 400 (FIG. 4). In some embodiments, the storage medium 604 also stores information for performing a portion or all of the operations as described in method 200 (FIG. 2) or method 400 (FIG. 4) as well as information generated during performing a portion or all of the operations as described in method 200 (FIG. 2) or method 400 (FIG. 4).

System 600 includes I/O interface 612. I/O interface 612 is coupled to external circuitry. In some embodiments, I/O interface 612 includes a keyboard, keypad, mouse, trackball, trackpad, and/or cursor direction keys for communicating information and commands to processor 602.

System 600 includes display 614. The display 614 is electrically connected to the processor 602, storage medium 604, and I/O 612 via bus 510. The display 614 is a touch screen display 614 provided with a display device such as a liquid crystal display (LCD), a light-emitting diodes (LED) display, or an organic light-emitting diode (OLED or organic LED). The display 614 displays one or more user interfaces or screens including a camera view screen (FIG. 3B), a dialing screen (FIGS. 3A, 3C, and 5C), and a messaging user interface(s) (FIGS. 5A and 5B). The display 614 is further provided with a touch screen that detects a contact of a finger, a pen, a stylus pen or the like on the touch screen. The contact includes, but not limited to, touch, long touch, release, swipe, tap, double tap, and long tap.

System 600 includes camera 616 for capturing an object. The camera 616 includes one or more optical sensors, such as charge-coupled device (CCD) or complementary metal-oxide semiconductor (CMOS) phototransistors. Optical sensor(s) optionally capture still images and/or video.

System 600 also includes network interface 618 coupled to the processor 602. The network interface 618 allows system 600 to communicate with network 620, to which one or more other computer systems are connected. Network interface 618 includes wireless network interfaces such as BLUETOOTH, WIFI, WIMAX, GPRS, or WCDMA; or wired network interface such as ETHERNET, USB, or IEEE-1394. In some embodiments, method 200 (FIG. 2) or method 400 (FIG. 4) is implemented in two or more systems 600, and information is exchanged between different systems 600 via network 620.

An aspect of this description relates to a mobile device. The mobile device includes a display; a non-transitory computer readable medium configured to store instructions thereon; and a processor connected to the non-transitory computer readable medium and the display. The processor is configured to execute the instructions for receiving image data. The processor is further configured to execute the instructions for determining a phone number based on the imaging data. The processor is further configured to execute the instructions for, in response to the phone number being determined, automatically causing the display to: display the phone number, wherein the display is configured to receive instructions contacting the displayed phone number. In some embodiments, the mobile device further includes a camera, and the processor is configured to execute the instructions for receiving the image data from the camera. In some embodiments, the processor is configured to execute the instructions for: causing the display to display a first dialing screen including a button to activate the camera, and in response to the phone number being determined, automatically causing the display to display a second dialing screen including the phone number. In some embodiments, in response to the camera capturing an object including text, the processor is configured to execute the instructions for converting the captured object into the image data. In some embodiments, in response to the captured object being converted to the image data, the processor is configured to execute the instructions for: detecting the text in the image data; extracting numerical data from the detected text; determining the phone number based on the extracted numerical data; and automatically causing the display to display the phone number. In some embodiments, the display is configured to display a messaging user interface, and the processor is configured to execute the instructions for: receiving the image data from an image on the messaging user interface; detecting text from the image data; extracting numerical data from the detected text; determining the phone number based on the extracted numerical data; and automatically causing the display to display the phone number on the messaging user interface. In some embodiments, the processor is configured to execute the instructions for extracting numerical data from the image data. In some embodiments, the processor is configured to execute the instructions for validating the numerical data extracted from the image data based on a predetermined pattern to obtain one or more validated numbers. In some embodiments, the processor is configured to execute the instructions for formatting the one or more validated numbers based on a location of the mobile device. In some embodiments, the processor is configured to execute the instructions for determining a phone number with a highest probability among the one or more validated numbers to determine the phone number displayed on the display.

An aspect of this description relates to a method of a mobile device. The method includes receiving image data. The method further includes determining a phone number based on the image data. The method further includes in response to the phone number being determined, automatically displaying, on a display of the mobile device, the phone number, wherein the display receives instructions for contacting the displayed phone number. In some embodiments, the image data is received from a camera of the mobile device, and in response to the camera capturing an object including text, the method further includes converting the captured object into the image data. In some embodiments, the method further includes displaying a first dialing screen including a button to activate the camera, and in response to the phone number being determined, automatically displaying a second dialing screen including the phone number. In some embodiments, the method further includes detecting the text from the image data; extracting numerical data from the detected text; determining the phone number based on the extracted numerical data; and automatically displaying the phone number on the display. In some embodiments, the method further includes displaying an image on a messaging user interface, wherein the image data is received by detecting the image displayed on the messaging user interface. In some embodiments, the method further includes detecting text from the image data, extracting numerical data from the detected text; determining the phone number based on the extracted numerical data; and automatically displaying the phone number on the display. In some embodiments, the method further includes extracting numerical data from the image data. In some embodiments, the method further includes validating the numerical data extracted from the image data based on a predetermined pattern to obtain one or more validated numbers; and formatting the one or more validated numbers based on a location of the mobile device. In some embodiments, the method further includes determining a phone number with a highest probability among the one or more validated numbers to determine the phone number displayed on the display.

An aspect of this description relates to a non-transitory computer readable medium configured to store instructions for causing a processor executing the instructions to implement a method. The instructions cause the processor to receive image data. The instructions further cause the processor to determine a phone number based on the image data. The instructions further cause the processor to automatically display, on a display of the mobile device, the phone number, wherein the display receives instructions for contacting the displayed phone number.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A mobile device comprising:
a display;
a non-transitory computer readable medium configured to store instructions thereon; and
a processor connected to the non-transitory computer readable medium and the display, wherein the processor is configured to execute the instructions for:
receiving image data;
determining a phone number based on the imaging data; and
in response to the phone number being determined, automatically causing the display to display the phone number, wherein the display is configured to receive instructions for contacting the displayed phone number.

2. The mobile device according to claim 1, further comprising a camera, wherein the processor is configured to execute the instructions for receiving the image data from the camera.

3. The mobile device according to claim 2, wherein in response to the camera capturing an object including text, the processor is configured to execute the instructions for converting the captured object into the image data.

4. The mobile device according to claim 2, wherein the processor is configured to execute the instructions for:
causing the display to display a first dialing screen including a button to activate the camera, and
in response to the phone number being determined, automatically causing the display to display a second dialing screen including the phone number.

5. The mobile device according to claim 4, wherein in response to the captured object being converted to the image data, the processor is configured to execute the instructions for:
detecting the text in the image data;
extracting numerical data from the detected text;
determining the phone number based on the extracted numerical data; and
automatically causing the display to display the phone number.

6. The mobile device according to claim 1, wherein
the display is configured to display a messaging user interface; and
the processor is configured to execute the instructions for:
receiving the image data from an image on the messaging user interface;
detecting text from the image data;
extracting numerical data from the detected text;
determining the phone number based on the extracted numerical data; and
automatically causing the display to display the phone number on the messaging user interface.

7. The mobile device according to claim 1, wherein the processor is configured to execute the instructions for extracting numerical data from the image data.

8. The mobile device according to claim 7, wherein the processor is configured to execute the instructions for validating the numerical data extracted from the image data based on a predetermined pattern to obtain one or more validated numbers.

9. The mobile device according to claim 8, wherein the processor is configured to execute the instructions for formatting the one or more validated numbers based on a location of the mobile device.

10. The mobile device according to claim 9, wherein the processor is configured to execute the instructions for determining a phone number with a highest probability among the one or more validated numbers to determine the phone number displayed on the display.

11. A method of a mobile device, the method comprising:
receiving image data;
determining a phone number based on the image data; and
in response to the phone number being determined, automatically displaying, on a display of the mobile device, the phone number, wherein the display receives instructions for contacting the displayed phone number.

12. The method according to claim 11, wherein
the image data is received from a camera of the mobile device, and
in response to the camera capturing an object including text, the method further comprises converting the captured object into the image data.

13. The method according to claim 12, further comprising:
displaying a first dialing screen including a button to activate the camera, and
in response to the phone number being determined, automatically displaying a second dialing screen including the phone number.

14. The method according to claim 12, further comprising:
detecting the text from the image data;
extracting numerical data from the detected text;
determining the phone number based on the extracted numerical data; and
automatically displaying the phone number on the display.

15. The method according to claim 11, further comprising displaying an image on a messaging user interface, wherein
the image data is received by detecting the image displayed on the messaging user interface.

16. The method according to claim 15, further comprising:
detecting text from the image data;
extracting numerical data from the detected text;
determining the phone number based on the extracted numerical data; and
automatically displaying the phone number on the display.

17. The method according to claim 11, further comprising: extracting numerical data from the image data.

18. The method according to claim 17, further comprising:
validating the numerical data extracted from the image data based on a predetermined pattern to obtain one or more validated numbers; and
formatting the one or more validated numbers based on a location of the mobile device.

19. The method according to claim 18, further comprising: determining a phone number with a highest probability among the one or more validated numbers to determine the phone number displayed on the display.

20. A non-transitory computer readable medium in a mobile device configured to store instructions for causing a processor of the mobile device executing the instructions to implement a method comprising:
receiving image data;
determining a phone number based on the image data; and
in response to the phone number being determined, automatically displaying, on a display of the mobile device, the phone number, wherein the display receives instructions for contacting the displayed phone number.
